(19) United States
(12) Patent Application Publication
(10) Pub. No.: US 2008/0177666 A1
(43) Pub. Date: Jul. 24, 2008

(54) System for managing rental access by a user to an audio or audiovisual work

(76) Inventor: Richard LeBlanc, Le Raincy (FR)

Correspondence Address: YOUNG & THOMPSON, 209 Madison Street, Suite 500, ALEXANDRIA, VA, 22314, US

(21) Appl. No.: 11/657,633

(22) Filed: Jan. 25, 2007

Related U.S. Application Data
(63) Continuation of application No. PCT/FR07/00136, filed on Jan. 24, 2007.

(51) Int. Cl. H04L 9/00

(52) U.S. Cl. 705/54

(57) ABSTRACT

The system includes elements (1, 7) forming a server for the rental of a catalog of works, elements (7) for the user's selection of at least one work, elements (7) for writing to members (10) forming a user's medium for the storage of a copy of the selected work and of authorization data for access to it, and of copies of other works which are not selected but which are offered for rental and for which the access authorization data are stored in elements (14) forming a server for managing access authorization data, reading elements (11) of the members forming a medium (10) allowing access to the copy of the rented work, using the access authorization data written to the members forming the medium (10) and to the copies of the offered works, using access authorization data obtained from the elements(14) forming a server for managing the access authorization data.

The present invention relates to a system for managing rental access by a user to an audio or audiovisual work.

Services for the rental of audio or audiovisual works are currently provided at rental stores or rental terminals, where users can select and rent a film, for example.

In this case, the user selects a film which he wishes to rent and obtains in return for this a cassette or a DVD, for example, containing this film.

After watching the film, the user must return the cassette or DVD to the store or terminal.

However, these rental services clearly have a certain number of drawbacks, particularly in relation to their provision.

This is because, in the first place, the stores and/or distribution terminals require maintenance. Additionally, the stocking of these stores or terminals with a sufficient number of cassettes or DVDs also poses a certain number of problems, and a user cannot be sure of obtaining the work which he wishes to rent, because of the limited number of media available in a store or terminal of this type.

To overcome these problems, the applicant has already proposed, in patent application FR 06 09598 filed on 2 Nov. 2006, a system for managing rental access by a user to an audio or audiovisual work, comprising:
means of writing a copy of the work, in the form of a computer file, and traceability data for it, to a digital storage medium belonging to the user;
means for retrieving these traceability data and erasing the copy of the work on the medium after the user's visit to means of accessing the work; and
means for the comparative analysis of the written and retrieved traceability data for the purpose of monitoring rental access to the work.

According to other characteristics of this system:
the writing means and the retrieval and eraseion means are associated with means forming a server for the rental of works incorporated in a rental centre and having means for storing a catalog of works and means for the user's selection of one or more works;
the centre is incorporated into a network of rental centers associated with means for distributing the works via a data transmission network;
the means for distributing the works comprise a database for storing a catalog of works, means for encrypting these works by means of an encryption/decryption key supplied at least partially by a key server, and the means for the user's access to the work comprise means for decrypting the works by means of at least a part of the encryption/decryption key of the work delivered by a key server;
the means of access to the work include means for storing at least another part of the encryption/decryption key;
the center is adapted to write at least another part of the encryption/decryption key to the digital storage medium;
the user's digital storage medium takes the form of a rewritable digital disk;
the digital storage medium takes the form of a rewritable or magnetic semiconductor memory; and
the user's digital storage medium and the means of access to the work are combined into a single device.

The object of the invention is to improve this system further.

For this purpose, the invention proposes a system for managing the rental access of a user to audio or audiovisual works, characterized in that it comprises:
means forming a rental server for making available to the user a catalog of work which can be selected for rental;
means for the user's selection of at least one work which he wishes to rent from the catalog of works;
means for writing to nomadic means forming the medium for the user's digital storage of a copy of the work selected by the user and data concerning authorization for access to the work and copies of other works not selected by the user but offered for rental, the access authorization data for these works being stored in means forming a server for managing access authorization data; and
reading means of the means forming the user medium, allowing access to the copy of the rented work, using the corresponding access authorization data written to the means forming the medium, and to the copies of the offered works, using corresponding access authorization data obtained directly or via the user from the means forming the server for managing the access authorization data.

According to other characteristics of this system:
the reading means of the means forming a user medium are connected via a data transmission network to the means forming the server for managing the access authorization data to obtain the access authorization data directly;
the reading means comprise human/machine interface means for the user's input of access authorization data, and the user has means for remote access to the means forming the server for managing the access authorization data to obtain these data;
the user access means include a computer connected via a data transmission network to the means forming the server for managing the access authorization data;
the user access means include a telephone connected via a data transmission network to the means forming the server for managing the access authorization data;
the access authorization data comprise data chosen from the group comprising:
   data on keys for decrypting the copies of the works stored in the means forming a medium, the copies being encrypted;
   data for unlocking the keys for decrypting the copies of the works already written to the means forming a medium, the copies being encrypted, and/or
   data for unlocking the reading means;
the means forming the server for managing the access authorization data comprise means for accounting for and/or billing these accesses and for calculating the allocation of royalties to the beneficiaries of the works;
the means forming a rental server also include means for eraseing the copies of the works on the means forming the medium when these means forming the medium are subsequently taken into these means forming a rental server; and
the means forming a rental server are incorporated into a network of rental centers connected to means for distributing the works via a data transmission network.

The invention will be more clearly understood with the aid of the following description, provided solely by way of example, which refers to the attached figures, in which:

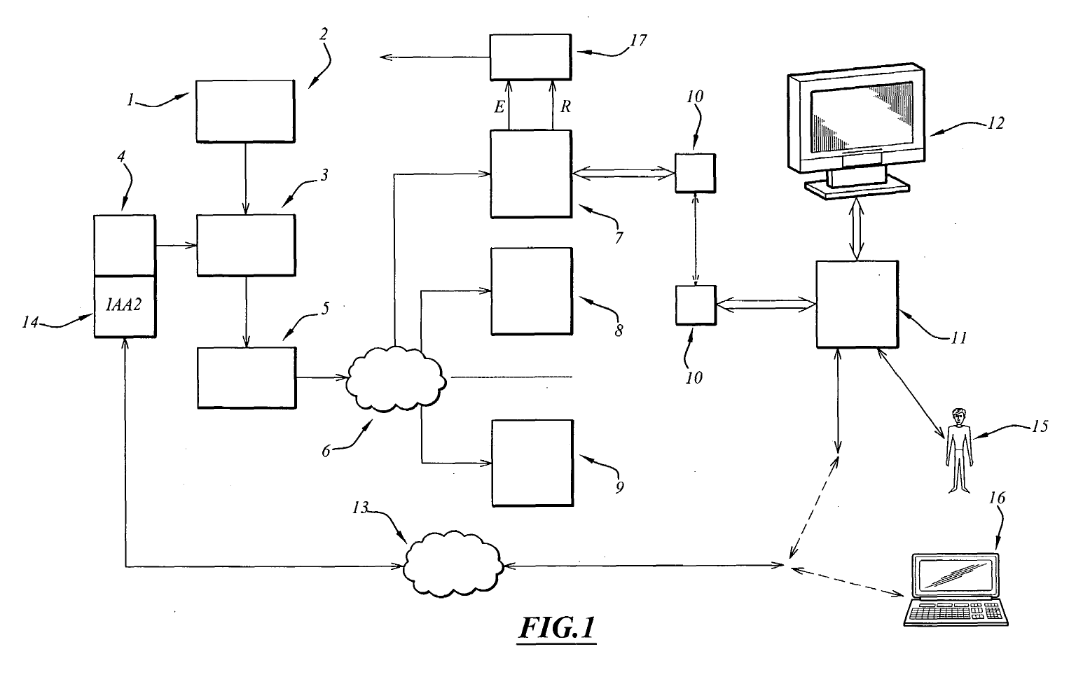

FIG. 1 shows a synoptic diagram illustrating the structure and operation of a management system according to the invention;

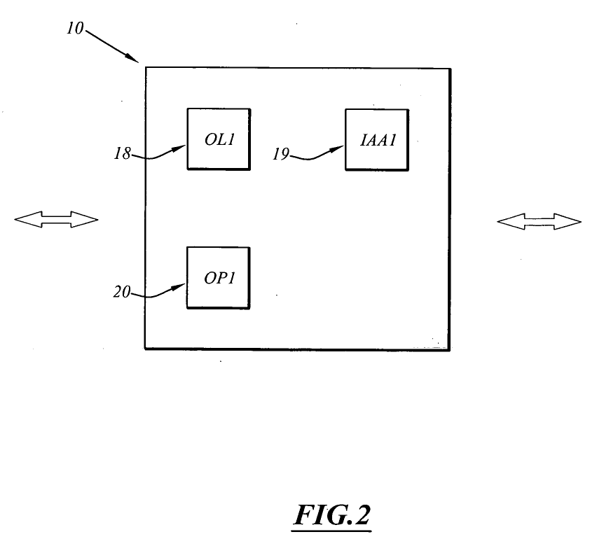

FIG. 2 shows the structure and operation 6f a storage medium forming part of this system.

FIG. 1 shows a system for managing a user's rental access to an audio or audiovisual work.

In the following description, an example of embodiment more specifically related to an audiovisual work, such as a film, will be described.

In the example of embodiment shown in FIG. 1, different audiovisual works, such as films, are stored in a database containing a catalog of works.

This database is indicated by the general reference 1 in this figure.

These works are, for example, supplied by studios or other sources.

This database is incorporated into means for distributing this catalog of works, indicated by the general reference 2 in this figure, which also include means 3 for encrypting the works, for example by means of encryption/decryption keys delivered by a key server indicated by the general reference 4.

The works encrypted in this way are then transmitted to a server for distributing this catalog of works, indicated by the general reference 5.

This distribution server 5 is, for example, connected to a data transmission network, indicated by the general reference 6, for distributing this catalog of works to different rental centers indicated by the general references 7, 8 and 9 in this figure.

Different embodiments of this network can be envisaged in a conventional way.

For example, these rental centers can take the form of rental terminals or rental points incorporated into stores or other facilities, and are, for example, distributed over a given territory.

Each rental center includes means for storing the distributed catalog, in order to place the corresponding works on rental for public use and for availability to users.

The works are then made available for rental by means of a nomadic digital storage medium belonging to the user, indicated by the general reference 10 in FIG. 1.

This user's digital storage medium can, for example, take the form of a rewritable digital disk or a rewritable semiconductor memory or any other digital storage medium on which data can be written and subsequently erased.

For example, a medium of the USB key type can be envisaged.

A user wishing to rent a film, for example, connects the user's digital storage medium, for example that indicated by 10, to the center, for example that indicated by 7.

In a conventional way, he selects the work or works which he wishes to rent and initiates the writing of a copy of the selected work or works, in the form of a computer file, and traceability data for it, by corresponding writing means of the center 7 to the storage medium 10.

These traceability data can have any appropriate format providing traceability of the rental and reading operation for the work.

In a specific embodiment, part of the encryption/decryption key can also be written by the center 7 to the digital storage medium 10. The user then has a digital storage medium on which is stored a file of the work which he has rented.

Additionally, the writing means of the center are adapted to write to the storage medium 10 not only a copy of the work selected by the user, but also data on the authorization of access to the work, which have been supplied to them by the distribution means, and copies of other works not selected by the user but offered for rental and for which the access authorization data are stored in the means forming the server for managing the access authorization data, which are described more fully below.

The access authorization data are, for example, data on the authorization for temporary access to the works in the course of the rental operation.

In this case, the writing means write not only a copy of the work or works selected by the user, but also copies of other works which can be associated with the work selected by the user according to a certain number of criteria, such as the criteria of the novelty of the Works, the user's customization profile, etc.

The user can then take this storage medium 10 to his home and connect it to means for reading the copies of the works, composed for example of an appropriate reader indicated by the general reference 11, connected to means for reproducing the work, such as a television or a monitor indicated by the general reference 12.

The reader 11 is based on the use of a data processing unit for decrypting the computer file of the work stored on the storage medium 10.

For this purpose, it should be noted that this reader can be made to use, for the decryption of this file, part of a key stored directly in this reader, which may or may not be associated with another part of a key stored on the user's digital storage medium 10 by the center 7 etc.

It can also be seen that the reader of the user's medium can be used for direct access to the copy of the work rented by the user, using the corresponding access authorization data written to the medium by the writing means on a visit to the center 7.

This reader can also be used to access the copies of the works offered, in other words those not initially rented by the user, by using corresponding access authorization data which can then be obtained, either directly or via the user, from the aforementioned means forming a server managing the access authorization data.

For this purpose, the reader 11 is connected, either directly or via the user, to a data transmission network 13 allowing access to these means forming the server for managing the access authorization data, which are indicated by the general reference 14 in this figure.

This figure shows two variant embodiments of this access. In the first variant, the reader 11 is directly connected to the data transmission network 13 and therefore to the means 14 forming a server for managing the access authorization data, to directly obtain the access authorization data when the user wishes.

In the second variant embodiment illustrated, the reader 11 comprises human/machine interface means for the input of the access authorization data by the user as indicated by the general reference 15 in this figure, this user also being provided in this case with means for remotely accessing the means 14 forming the server for managing the access authorization data to obtain these data.

Different embodiments of these remote access means of the user can be envisaged.

In the illustrated example of embodiment, these means are composed, for example, of a computer indicated by the general reference 16, connected to the means forming a server 14 via the data transmission network 13.

In another embodiment, the user can also use a telephone to obtain the corresponding access authorization data from the means forming a server 14.

These different means and these access authorization data can also be provided in different forms.

Thus, for example, these means forming an access authorization data server can be associated with the encryption/decryption key server, and the access authorization data can include data chosen from the group comprising data on the keys for decrypting the copies of the works stored in the means forming a medium, the copies being encrypted when written as mentioned above, data for unlocking the keys for decrypting the copies of the works already written to the means forming a medium, the copies being encrypted when written as mentioned above, and/or data for unlocking the reader, enabling these to access the works which are offered.

The means 14 forming the server for managing the access authorization data can also comprise means for accounting for and/or billing these accesses and for calculating the allocation of royalties to the beneficiaries of the works.

Clearly, other embodiments can be envisaged. Thus, for example, a device combining the functions of storage, reading and/or reproduction can be envisaged.

When he wishes, the user can then use the storage medium to rent another film from the center 7.

For this purpose, on a new visit to the center, he reconnects the user's digital storage medium 10 to this server center 7.

The server center 7 is then adapted to detect, for example, whether the selected film has actually been read, to retrieve the corresponding traceability data written to the medium 10 during the user's first visit, and to erase the copy of the work or works on this medium.

The medium is then ready for another rental operation as described above.

Each center, for example the center 7, is also associated with means for analyzing the rental accesses to the works.

These means are indicated by the general reference 17 in FIG. 1, and comprise a data processing unit which acquires the traceability data E written to the user's digital medium 10 during the user's first visit to the center when the film is selected, and which retrieves these traceability data R during the user's second visit to the center, after the user has accessed the work, in order to produce data for the comparative analysis of the written and retrieved traceability data.

This then makes it possible to monitor the rental access to the work by allowing a comparison of the traceability data written when the film is loaded to the medium and retrieved before the work is erased from the medium, indicating that the copy of the work has been returned or “surrendered”.

This secure management system enables the operator providing the rental network to assure those controlling the works that the works have in fact been distributed to the public and retrieved from them as part of a rental operation, since the rental center is adapted to write to the medium, and then erase from it, a copy of the work in the form of a computer file, and to ensure that the writing and erasure operations have actually been carried out, by using the written and retrieved traceability data.

FIG. 2 shows the operation of a user's digital storage medium such as the medium 10.

After it has been taken into the center 7, this medium contains copies of works such as a copy of a work selected and rented by the user, indicated by the general reference 18 in this figure and denoted OL1 in this figure, associated with the corresponding access authorization data indicated by the general reference 19 and denoted IAA1 in this figure.

If the user wishes to access the copy of this work, the reader uses the corresponding access authorization data 19 for the reproduction of this work 18.

Additionally, the center 7 has initiated the writing to the medium 10 of copies of works which are offered, in other words not initially selected by the user, such as the offered work indicated by the general reference 20 in this figure and denoted OP1.

However, the corresponding access authorization data are not stored wholly or partially in the storage medium 10, but in the means forming an access authorization data server 14 described above. The copy of the work OP1 is stored in the storage medium 10, but the authorization data for access to the work are not stored there, and consequently if the user wishes to access the copy of this work the corresponding access authorization data must be supplied to this reader by obtaining them from the means forming a server 14.

These data are then supplied either directly, if the reader is connected directly to the data transmission network 13 and to the server 14, or via the user, using for example means 16 for remotely accessing this server 14.

Clearly, even more embodiments can be envisaged.

1. System for managing a user's rental access to audio or audiovisual works, characterized in that it includes:
means (1, 7) forming a rental server for making available to the user a catalog of work which can be selected for rental,
means (7) for the user's selection of at least one work which he wishes to rent from the catalog of works;
means (7) for writing to nomadic means (10) forming the medium for the user's digital storage of a copy of the work (OL1) selected by the user and authorization data (IAA1) for access to the work and copies of other works (OP1) not selected by the user but offered for rental, the access authorization data (IAA2) for these works being stored in means (14) forming a server for managing access authorization data;
means (11) for reading the means forming the user medium (10), allowing access to the copy of the rented work (OL1), using the corresponding access authorization data (IAA1) written to the means forming the medium (10), and to the copies of the offered works (OD1), using corresponding access authorization data (IAA2) obtained directly or via the user from the means (14) forming the server for managing the access authorization data.

2. Management system according to claim 1, characterized in that the reading means (11) of the means forming a user medium (10) are connected via a data transmission network (13) to the means (14) forming the server for managing the access authorization data to obtain the access authorization data directly.

3. Management system according to claim 1, characterized in that the reading means (11) comprise human/machine interface means for the input of access authorization data by the user (15), and in that the user has means (10) for remote access to the means (14) forming the server for managing the access authorization data to obtain these data.

4. Management system according to claim 3, characterized in that the user's access means include a computer (16) connected to the means (14) forming a server for managing the access authorization data via a data transmission network (13).

5. Management system according to claim 3, characterized in that the user's access means include a telephone connected via a data transmission network (13) to the means (14) forming a server for managing the access authorization data.

6. Management system according to claim 1, characterized in that the access authorization data comprise data chosen from the group comprising:
data on keys for decrypting the copies of the works stored in the means forming a medium, the copies being encrypted;
data for unlocking the keys for decrypting the copies of the works already written to the means forming a medium (10), the copies being encrypted, and/or
data for unlocking the reading means (11).

7. Management system according to claim 1, characterized in that the means (14) forming a server for managing the access authorization data comprise means for accounting for and/or billing these accesses and for calculating the allocation of the royalties to the beneficiaries of the works.

8. Management system according to claim 1, characterized in that the means (7) forming a rental server also include means for erasing the copies of the works on the means (10) forming the medium when these means forming the medium are subsequently taken into these means forming a rental server.

9. Management system according to claim 1, characterized in that the means forming the rental server (7) are incorporated into a network of rental centers (7, 8, 9) connected to means (1, 2, 3, 5) for distributing the works via a data transmission network (6).

10. Management system according to claim 2 characterized in that the access authorization data comprise data chosen from the group comprising:
data on keys for decrypting the copies of the works stored in the means forming a medium, the copies being encrypted;
data for unlocking the keys for decrypting the copies of the works already written to the means forming a medium (10), the copies being encrypted, and/or
data for unlocking the reading means (11).

11. Management system according to claim 2 characterized in that the means (14) forming a server for managing the access authorization data comprise means for accounting for and/or billing these accesses and for calculating the allocation of the royalties to the beneficiaries of the works.

12. Management system according to claim 2 characterized in that the means (7) forming a rental server also include means for erasing the copies of the works on the means (10) forming the medium when these means forming the medium are subsequently taken into these means forming a rental server.

13. Management system according to claim 2, characterized in that the means forming the rental server (7) are incorporated into a network of rental centers (7, 8, 9) connected to means (1, 2, 3, 5) for distributing the works via a data transmission network (6).
